(19) United States
(12) Patent Application Publication
(10) Pub. No.: US 2026/0030043 A1
(43) Pub. Date: Jan. 29, 2026

(54) DYNAMIC CONTENT ADAPTATION

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN)

(21) Appl. No.: 18/787,135

(22) Filed: Jul. 29, 2024

(51) Int. Cl. G06F 9/451; H04L 67/306

(52) U.S. Cl. CPC G06F 9/454; H04L 67/306

(57) ABSTRACT

A method provides techniques for generating dynamically adapted content from received source content based on cultural and other differences and user/device presentation preferences. The method includes obtaining source content from a source application. The method further includes identifying one or more items of convertible information within the source content, and determining characteristics that can be correlated to device presentation preferences for presenting the source information in a format/style that matches the device presentation preferences. The method further includes creating a modified version of the source content with the at least one of the one or more items of convertible information converted to its renderable presentation alternative for presentation on the electronic device, and presenting the modified version of the source content via an output device such as an electronic display or audio speaker.

### BACKGROUND

### 1. Technical Field

The present disclosure generally relates to electronic devices, and more specifically to electronic devices that can be used for communication and Internet applications.

### 2. Description of the Related Art

Connected devices such as smartphones, tablet computers, desktop computers, laptop computers, and wearable computers allow users to consume content from around the world more easily than ever before. The Internet offers numerous benefits for these devices to communicate and access information globally. Sending messages via the Internet is rapid and efficient. Emails, instant messaging and video calls allow real-time communication across continents. The Internet offers various communication tools, such as websites, email, social media, and video conferencing. In addition to being used as a communication tool, many people use the Internet as a news source. Internet news may provide a broader view of current events worldwide. Using the Internet, it is possible to stay informed about political, economic, and cultural developments happening beyond the local area of a user. Moreover, reading news from various sources allows one to explore different viewpoints and storytelling styles. Thorough reporting can offer new insights and help one see the world from different perspectives.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to implement dynamic content adaptation, according to one or more embodiments;

FIG. 2 is an example illustration of an electronic device transmitting a request to a network device for dynamic content adaptation, according to one or more embodiments;

FIG. 3 depicts an example of dynamic content adaptation with monetary currency, according to one or more embodiments;

FIG. 4 depicts an example of dynamic content adaptation showing conversion of an idiomatic expression to literal text, according to one or more embodiments;

FIG. 5 depicts an example of dynamic content adaptation showing time zone conversion, according to one or more embodiments;

FIG. 6 depicts an example of dynamic content adaptation showing conversion of a first idiomatic expression to a second idiomatic expression, according to one or more embodiments;

FIG. 7 depicts an example of dynamic content adaptation showing conversion of a numeric delimiting scheme, according to one or more embodiments;

FIG. 8 depicts an example of dynamic content adaptation showing word regionalization, according to one or more embodiments;

FIG. 9 depicts an example of dynamic content adaptation with audio, according to one or more embodiments;

FIG. 10 depicts an example of dynamic content adaptation showing conversion of a unit of measurement, according to one or more embodiments;

FIG. 11 shows an exemplary user interface for configuring dynamic content adaptation options, according to one or more embodiments.

FIG. 12 depicts a flowchart of a computer-implemented method for dynamic content adaptation, according to one or more embodiments; and

FIG. 13 depicts a flowchart of an additional computer-implemented method for dynamic content adaptation, according to one or more embodiments.

### DETAILED DESCRIPTION

According to aspects of the present disclosure, an electronic device, a method, and a computer program product provide techniques for dynamic content adaptation. When reading information, such as news, from other countries, several challenges can arise due to cultural and regional language differences and other factors. Cultural context significantly impacts language usage. When communicating with others from a different cultural or geographic background, idiomatic expressions, humor, and metaphors may not translate directly. For example, a phrase like “raining cats and dogs” might confuse readers unfamiliar with English idioms. Different regions may use distinct words for the same concept. For instance, in the United States, an apparatus to travel between floors in a multistory building is an “elevator,” while in the United Kingdom, the same apparatus may be referred to as a “lift.” These regional variations can lead to confusion or misinterpretation. Additionally, news articles often mention prices, economic data, or measurements. Currency differences (e.g., dollars, euros, yen) and varying units (metric vs. imperial/standard) can impede comprehension of the information. These, and other regional differences can cause misunderstandings and/or frustration for users when trying to consume content and/or communicate with others from different regions. The disclosed embodiments alleviate the aforementioned issues that can occur when encountering unfamiliar terms and/or dialect that is due to regional and/or cultural differences.

According to one or more embodiments, a locale is established for a user's device, and user preferences may be established. A locale in a computer system refers to a set of parameters that define the user's regional and cultural preferences. Received source content is analyzed for convertible information. The convertible information is converted according to user preferences and the user's locale. The convertible information can include currency values, dates, times, units of measurement, numeric delimiting schemes, and/or other convertible information. In particular, the convertible information can include regional dialect differences, as well as conversion of idiomatic expressions to literal text, or conversion of a first idiomatic expression in a first region to a second idiomatic expression, each in accordance with a user's locale and/or user preferences. In this way, disclosed embodiments can simplify and streamline written communication between different parts of the world, thereby providing improved user experiences.

One or more embodiments can include an electronic device including: at least one output device, including a display; a memory having stored thereon a dynamic content adaptation (DCA) module; and at least one processor communicatively coupled to the display and the memory, the at least one processor executing program code of the DCA module, and is configured to cause the electronic device to: obtain source content from a source application; identify one or more items of convertible information within the source content; determine, in part based on user profile data associated with a user of the electronic device, characteristics that can be correlated to device presentation preferences for one or more convertible information items outputted on the electronic device, wherein the one or more convertible information items are presented within the source content using a different presentation format than renderable presentation alternatives that match the device presentation preferences for at least one of the one or more convertible information; render a modified version of the source content with the at least one of the one or more items of convertible information converted to its renderable presentation alternative for presentation on the electronic device; and present the modified version of the source content via the at least one output device.

One or more embodiments can include a method including: obtaining, by a processor of an electronic device that comprises a display, source content from a source application; identifying one or more items of convertible information within the source content; determining, in part based on user profile data associated with a user of the electronic device, characteristics that can be correlated to device presentation preferences for one or more convertible information items outputted on the electronic device, wherein the one or more convertible information items are presented within the source content using a different presentation format than renderable presentation alternatives that match the device presentation preferences for at least one of the one or more convertible information; rendering a modified version of the source content with the at least one of the one or more items of convertible information converted to its renderable presentation alternative for presentation on the electronic device; and presenting the modified version of the source content via the at least one output device.

One or more embodiments can include a computer program product comprising a non-transitory computer readable medium having program instructions that when executed by a processor of an electronic device comprising a display, configure the electronic device to perform functions comprising: obtaining source content from a source application; identifying one or more items of convertible information within the source content; determining, in part based on user profile data associated with a user of the electronic device, characteristics that can be correlated to device presentation preferences for one or more convertible information items outputted on the electronic device, wherein the one or more convertible information items are presented within the source content using a different presentation format than renderable presentation alternatives that match the device presentation preferences for at least one of the one or more convertible information items; rendering a modified version of the source content with the at least one of the one or more items of convertible information converted to its renderable presentation alternative for presentation on the electronic device; and presenting the modified version of the source content via the at least one output device.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

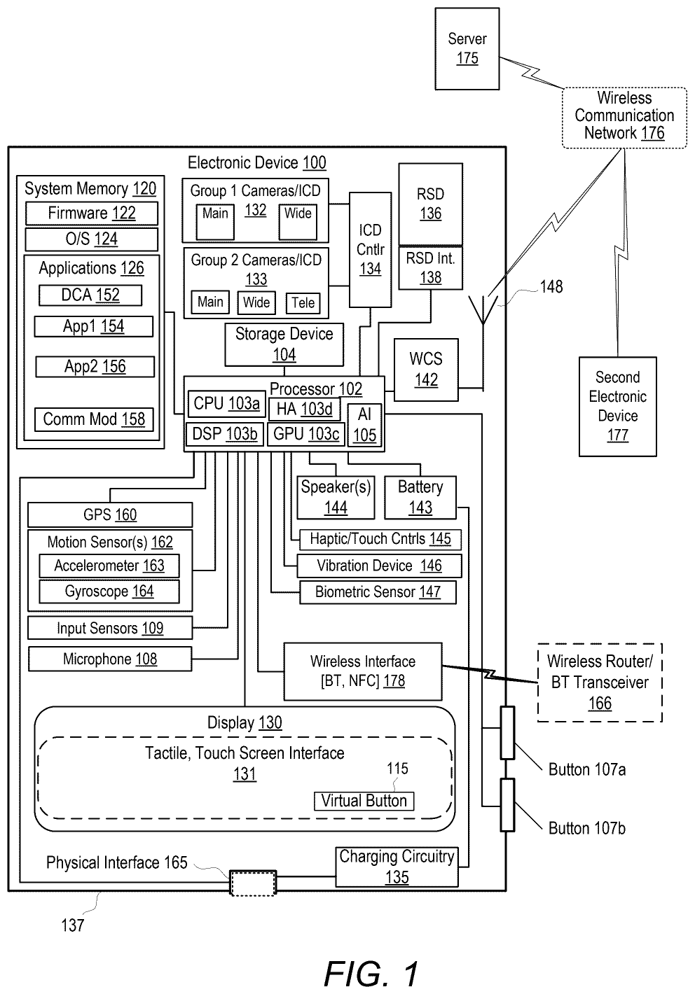

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that enable the device to provide dynamic content adaptation functions, according to one or more embodiments. Examples of electronic device 100 include, but are not limited to, mobile devices, a notebook computer, a mobile phone, a smart phone, a desktop computer, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, DCA module 152, additional applications indicated as App1 154, App2 156, and communication module 158. Other applications may also be present. Each module and/or application provides program instructions/code that are processed by processor 102 to cause/configure processor 102 and/or other components of electronic device 100 to perform specific operations, as described herein. Descriptive names assigned to these modules add no functionality and are provided solely to identify the underlying features performed by processing the different modules. For example, DCA module 152 can include program instructions for implementing features of disclosed embodiments. In particular, DCA module 152 can include instructions that, when executed by processor 102, causes or configures processor 102 and/or generally electronic device 100, to perform dynamic content adaptation.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes an integrated display 130, which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 115. In one or more embodiments, when a user applies a finger on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface. Other embodiments provide for multiple integrated displays within electronic device 100 and references to integrated display 130 are assumed to refer to one or all of these multiple integrated displays.

Electronic device 100 can further include microphone 108, one or more output devices such as speakers 144, and one or more input buttons, indicated as 107a and 107b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. Additionally, electronic device 100 can include input sensors 109 (e.g., sensors enabling gesture detection by a user).

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera) for user detection/identification.

GPS module 160 can provide time data and location data about the physical location of electronic device 100 using geospatial input received from GPS satellites. In one embodiment, GPS data can be used to determine a geographic location of electronic device 100 and the data can then trigger application of specific locale-based adaptations when presenting and interpreting received content. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be used as a power supply port that is coupled to charging circuitry 135 and device battery 143 to enable recharging of device battery 143 and/or powering of device.

Electronic device 100 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices, such as second electronic device 177, which can be similarly connected to wireless communication network 176. In one or more embodiments, various functions that are being performed on communications device 100 can be supported using or completed via/on server 175. For example, in one or more embodiments, server 175 can perform some aspects of dynamic content adaptation.

Electronic device 100 can also wirelessly communicate, via wireless interface(s) 178, with wireless communication network 176 via communication signals transmitted by short range communication device(s). Wireless interface(s) 178 can be a short-range wireless communication component providing Bluetooth, near field communication (NFC), and/or wireless fidelity (Wi-Fi) connections. In one or more embodiments, electronic device 100 can receive Internet or Wi-Fi based calls, text messages, multimedia messages, and other notifications via wireless interface(s) 178. In one or more embodiments, electronic device 100 can communicate wirelessly with external wireless device 166, such as a WiFi router or BT transceiver, via wireless interface(s) 178, which in turn enables communication with one or more second electronic devices 177 and/or server 175. In one or more embodiments, WCS 142 with antenna(s) 148 and wireless interface(s) 178 collectively provide wireless communications subsystem of electronic device 100.

Electronic device 100 of FIG. 1 is only a specific example of a device that can be used to implement the embodiments of the present disclosure. Devices that utilize aspects of the disclosed embodiments can include, but are not limited to, a smartphone, a tablet computer, a laptop computer, a desktop computer, a wearable computer, and/or other suitable electronic device.

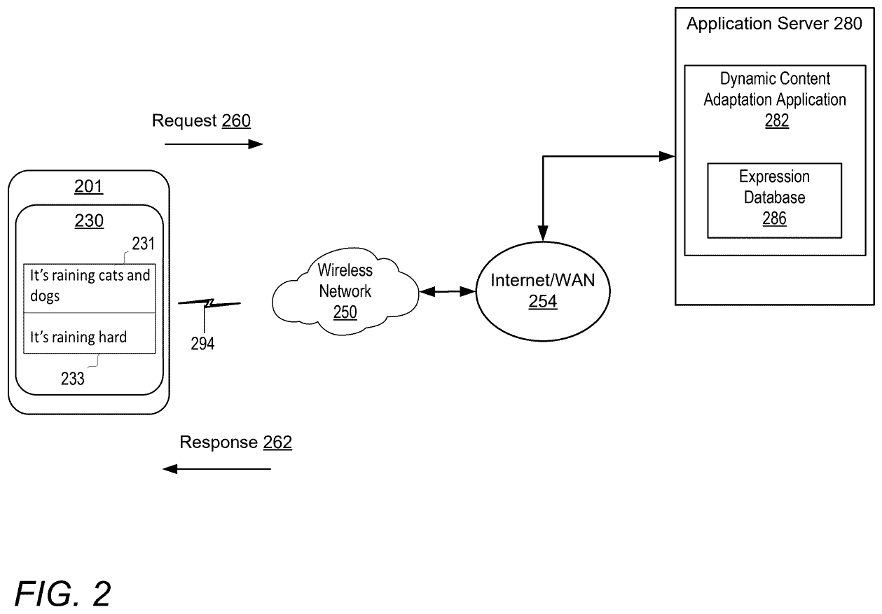

FIG. 2 is an example illustration of an electronic device transmitting a request for dynamic content adaptation to an application computer system, such as application server 280, and receiving a response from the application computer system for dynamic content adaptation, according to one or more embodiments. Device 201 includes a display 230 on which dynamically adapted content can be rendered. Device 201 can be an implementation of electronic device 100, having similar components and/or functionality. In one or more embodiments, at least some of the dynamic content adaptation and/or management functions may be implemented on a network-accessible application server, such as indicated by application server 280. Application server 280 is communicatively coupled to Internet/WAN 254. In one or more embodiments, Internet/WAN 254 can include one or more wide area networks (WANs) and/or the Internet. In one or more embodiments, electronic device 201 can communicate wirelessly with wireless network 250 via transmissions of communication signals 294 to and from network communication devices, such as base stations or cellular nodes, that can include components of network 250. Network 250 enables exchange of data between electronic device 201 and application server 280, via Internet/WAN 254.

Application server 280 can host dynamic content adaptation application 282. The dynamic content adaptation application 282 can include and/or have access to an expression database 286. The expression database 286 can include tables of idiomatic expressions for various regions, and equivalent literal text and/or equivalent idiomatic expressions for other regions. Additionally, the dynamic content adaptation application 282 can include and/or have access to, one or more AI models configured to output generative content. In one or more embodiments, the generative content can include dynamically adapted content that includes replacements for idiomatic expressions. In one or more embodiments, the AI models for producing generative content can include GPT-4 (Generative Pre-trained Transformer 4) PaLM 2, LaMDA (Language Model for Dialogue Applications), and/or other suitable models. The application server 280 and electronic device 201 may communicate with each other via Internet/WAN 254.

As shown in FIG. 2, content 231 contains an idiomatic expression: “It's raining cats and dogs.” Additionally, content 233 rendered below content 231 contains equivalent literal text of “It's raining hard.” Accordingly, a reader that is not familiar with the idiomatic expression “It's raining cats and dogs” can easily comprehend the content by referring to the literal text in content 233. In one or more embodiments, the request 260 and response 262 may utilize Hypertext Transfer Protocol (HTTP) and/or its secure counterpart HTTPS. Embodiments may use RESTful APIs, JavaScript Object Notation (JSON), Simple Object Access Protocol (SOAP), and/or other communication techniques for exchanging information.

In one or more embodiments, in order to support scalability and/or case of maintenance, application server 280 may be implemented via virtualization, such as utilizing hypervisors like VMware, Hyper-V, or KVM. One or more embodiments may include containerization services such as docker, LXC, or other suitable container framework to enable multiple isolated user-space instances. Additionally, one or more embodiments may include load balancing and/or orchestration, such as utilizing Kubernetes, or other suitable orchestration framework.

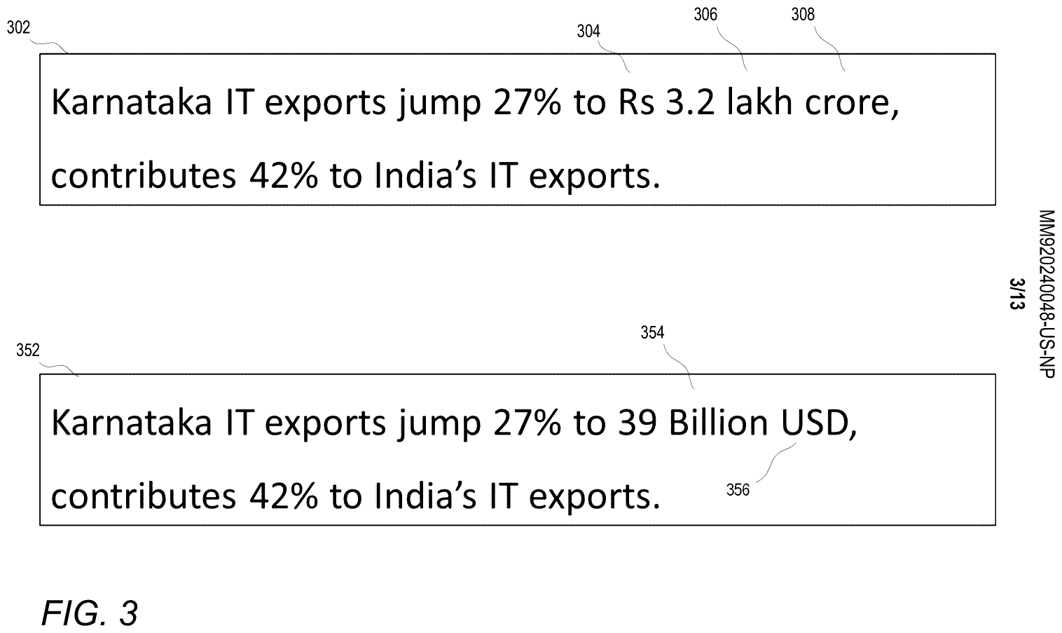

FIG. 3 depicts an example of dynamic content adaptation with monetary currency, according to one or more embodiments. Content 302 contains a sentence “Karnataka IT exports jump 27% to Rs 2.3 lakh crore contributes 42% to India's IT exports.” The content 302 contains numerous entities that are specific to (or commonly encountered in) India. The entities include a currency indication of Rs at 304, which indicates an amount of Indian Rupees. Moreover, the content 302 contains region-specific numeric values in terms of lakh 306 and crore 308. A lakh represents a value of one hundred thousand. A crore represents a value of ten million. For a reader not familiar with the region-specific terms, the content 302 can be challenging to completely comprehend. Disclosed embodiments perform dynamic content adaptation to render adapted content 352, which is well-suited for an American reader. The currency unit of Rupees (Rs) at 304 is converted to USD at 356. Moreover, the region-specific terms of lakh and crore are converted to a value in billions of dollars, as indicated at 354. Thus, disclosed embodiments can include: identifying a currency amount and currency type in the source content; determining a default currency type based on the user profile data; and in response to the default currency type not matching the currency type in the source content, converting the currency amount to the default currency type within the modified version of the source content. In one or more embodiments, the adapted content 352 may be shown instead of, or in addition to, the original source content 302. In one or more embodiments, the adapted content can include an adapted numeric representation, such as converting lakh and/or crore to billions. In one or more embodiments, the conversion may be approximate, and rounding up or down may be performed as part of the conversion.

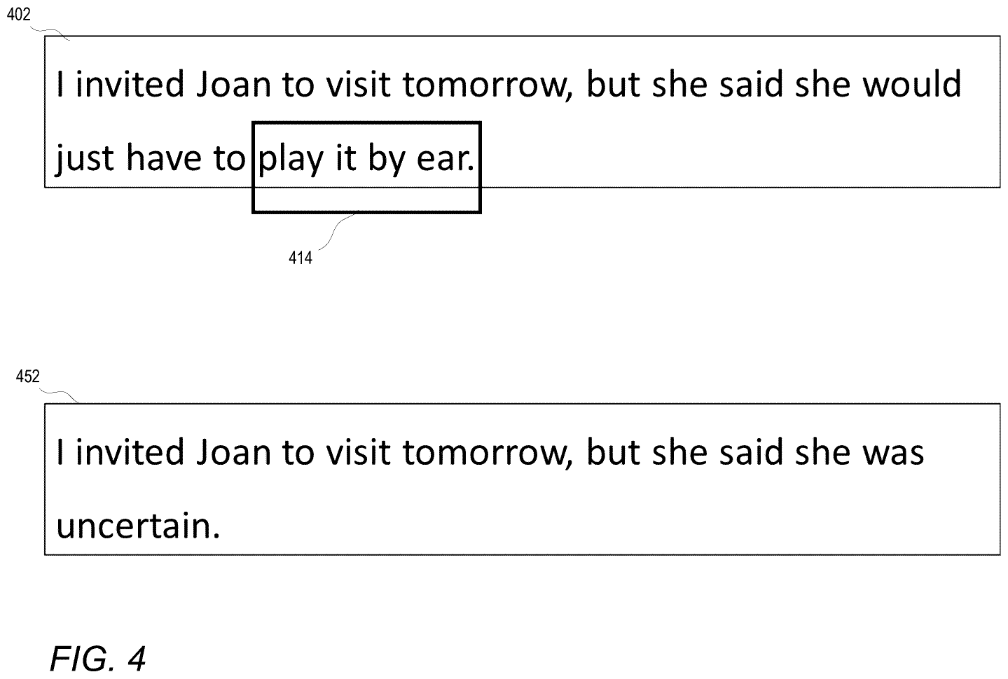

FIG. 4 depicts an example of dynamic content adaptation showing conversion of an idiomatic expression to literal text, according to one or more embodiments. Content 402 contains a sentence “I invited Joan to visit tomorrow, but she said she would just have to play it by ear.” The content 402 contains an idiomatic expression, indicated at 414, which includes the phrase “play it by ear.” The generally accepted meanings of the idiomatic expression “play it by ear” include meaning to decide later, or to have uncertainty regarding plans. In one or more embodiments, idiomatic expressions may be identified via comparing the content 402 with expressions in expression database 286 (FIG. 2). If an idiomatic expression is identified, a literal text equivalent may be retrieved from the expression database 286 (FIG. 2). For the example of the idiomatic expression “play it by ear,” the expression database 286 (FIG. 2) may contain a definition of “uncertain.” In one or more embodiments, a generative AI model creates dynamically adapted content that replaces the idiomatic expression, indicated at 414, with literal text based on the definition of the idiomatic expression. In embodiments, the AI model can be implemented in dedicated artificial intelligence (AI) engines 105 (FIG. 1) and/or on a remote computing device, such as via dynamic content adaptation application 282 on server 280 (FIG. 2). Disclosed embodiments perform dynamic content adaptation to render adapted content 452. The adapted content 452 contains the sentence “I invited Joan to visit tomorrow, but she was uncertain.” Accordingly, the adapted content 452 is well-suited for readers that may be able to read English, but are unfamiliar with many common English idiomatic expressions.

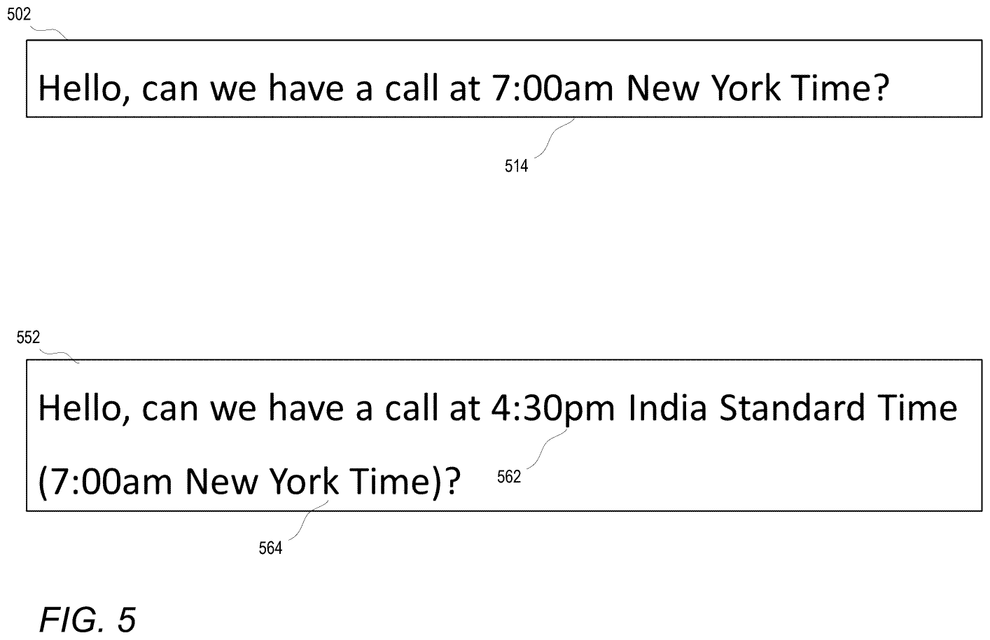

FIG. 5 depicts an example of dynamic content adaptation showing time zone conversion, according to one or more embodiments. Content 502 contains a sentence “Hello, can we have a call at 7:00 am New York Time?” The content 502 contains a time specified in the New York (Eastern) time zone, indicated at 514. One or more embodiments are configured to perform dynamic content adaptation to render adapted content 552 which has the time specified in the source time zone converted to a different time zone. The different time zone can be based on user preferences and/or a current physical location of the electronic device on which the dynamic content adaptation is performed. In one or more embodiments, the current physical location of the electronic device may be established using data provided by the GPS module 160 (FIG. 1). The adapted content 552 contains the sentence “Hello, can we have a call at 4:30 pm India Standard Time (7:00 am New York Time)?” The adapted content 552 contains the dynamically adapted content, indicated at 562, along with the original content, indicated at 564. Thus, one or more embodiments can include rendering, on the display, each of the one or more items of convertible information in the source content, concurrently with a corresponding renderable presentation alternative. Additionally, one or more embodiments can include: identifying a time and corresponding time zone in the source content; determining a default time zone based on the user profile data; and in response to the default time zone not matching the time zone in the source content, converting the time to the default time zone within the modified version of the source content.

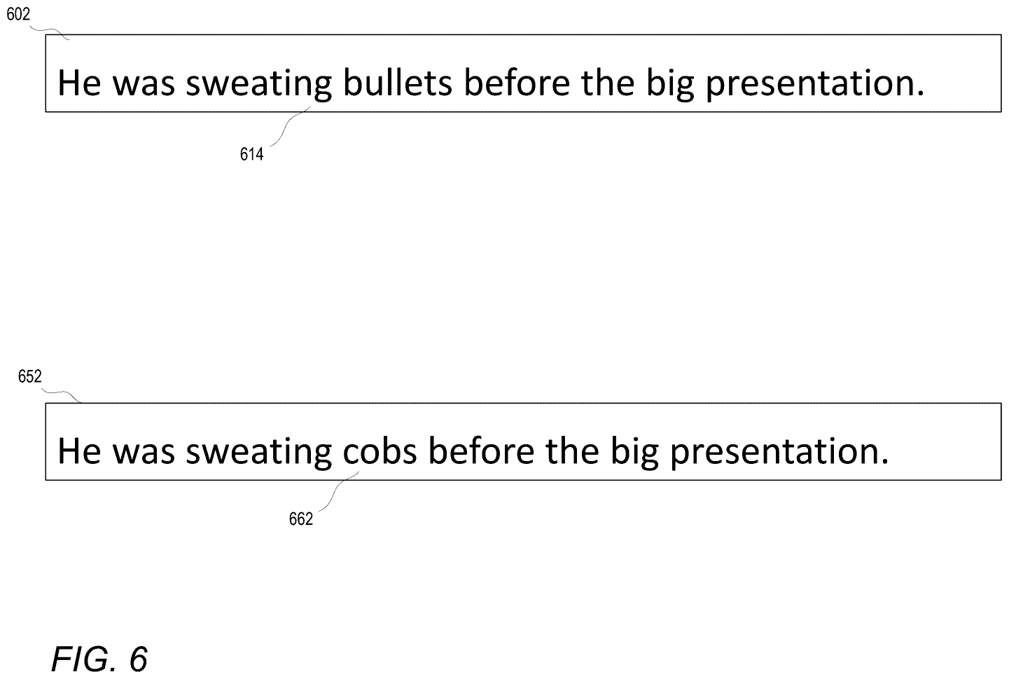

FIG. 6 depicts an example of dynamic content adaptation showing conversion of a first idiomatic expression to a second idiomatic expression, according to one or more embodiments. Content 602 contains a sentence “He was sweating bullets before the big presentation.” The content 602 contains an idiomatic expression, indicated at 614, which includes the phrase “sweating bullets.” The phrase “sweating bullets” is an American English idiomatic expression. For UK (United Kingdom) English, a different idiomatic expression “sweating cobs” conveys a similar sentiment of being nervous or anxious. One or more embodiments are configured to perform dynamic content adaptation to render adapted content 652 which has the UK version of the idiomatic expression, indicated at 662. Accordingly, the adapted content 652 is well-suited for readers that may be familiar with UK English, but are unfamiliar with many common American English idiomatic expressions. One or more embodiments can include: identifying an idiomatic expression in the source content; obtaining a corresponding idiomatic expression based on the user profile data; and replacing the idiomatic expression in the source content with the corresponding idiomatic expression within the modified version of the source content.

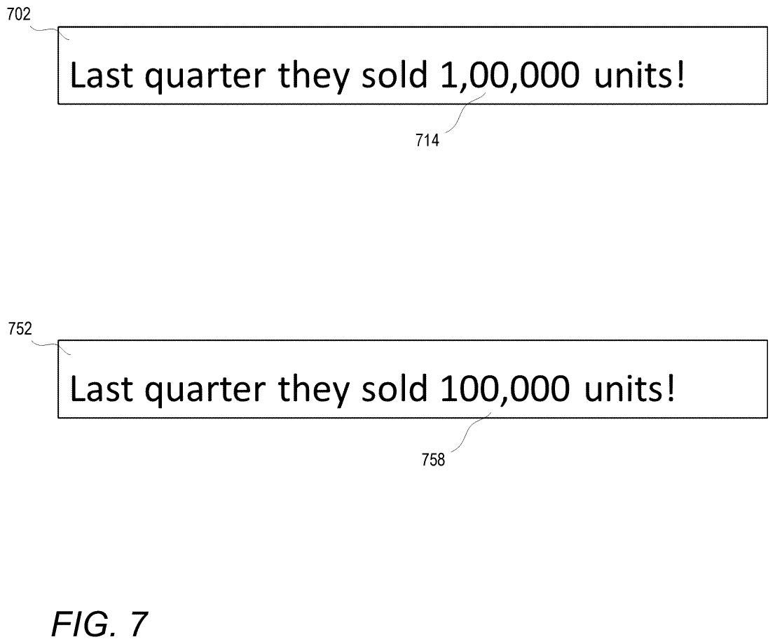

FIG. 7 depicts an example of dynamic content adaptation showing conversion of a numeric delimiting scheme, according to one or more embodiments. Content 702 contains a sentence “Last quarter they sold 1,00,000 units!” The content 702 contains a number indicated at 714 which is delimited in a style prevalent in India, where, starting from the least significant digit, the number includes three digits, followed by a comma, followed by two digits, followed by another comma, followed by another digit. The numeric delimiting scheme shown in content 702 may be familiar to a reader in India, but may be unfamiliar to an American reader. One or more embodiments are configured to perform dynamic content adaptation to render adapted content 752 which has a number indicated at 758 that uses a numeric delimiting scheme found in American English, in which case, starting from the least significant digit, the number includes three digits, followed by a comma, followed by another three digits. The number indicated at 714 has the same value as the number indicated at 758 (one hundred thousand), but the delimiting (number and placement of commas) is different for 714 as compared with 758. Accordingly, the adapted content 752 is well-suited for readers that may be familiar with American English, but are unfamiliar with the Indian numeric delimiting scheme shown at 714 in original content 702. One or more embodiments can include: identifying a numeric value and a numeric delimiting scheme in the source content; determining a default numeric delimiting scheme based on the user profile data; and in response to the default numeric delimiting scheme not matching the numeric delimiting scheme in the source content, applying the default numeric delimiting scheme to the numeric value.

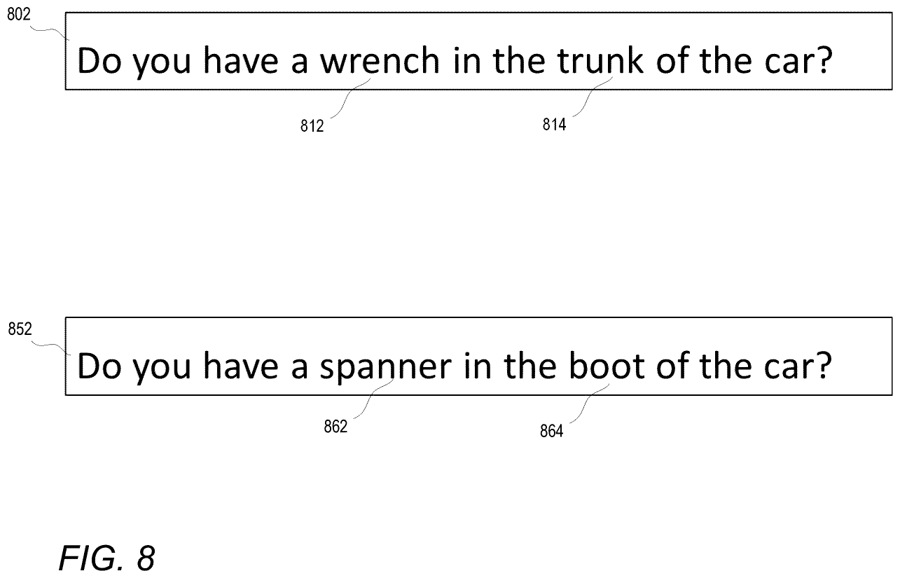

FIG. 8 depicts an example of dynamic content adaptation showing word regionalization, according to one or more embodiments. Content 802 contains a sentence “Do you have a wrench in the trunk of the car?” The word ‘wrench’ indicated at 812 and the word ‘trunk’ indicated at 814 are American English words that each have an equivalent word in UK English. One or more embodiments are configured to perform dynamic content adaptation to render adapted content 852 which has a sentence “Do you have a spanner in the boot of the car?” The word ‘spanner’ indicated at 862 is a UK English word that has a meaning similar to the word ‘wrench’ in American English. Similarly, the word ‘boot’ indicated at 864 is a UK English word that has a meaning similar to the word ‘trunk’ in American English. Accordingly, the adapted content 852 is well-suited for readers that may be familiar with UK English, but are unfamiliar with the particular regionalized words for American English shown at 812 and 814 in original content 802.

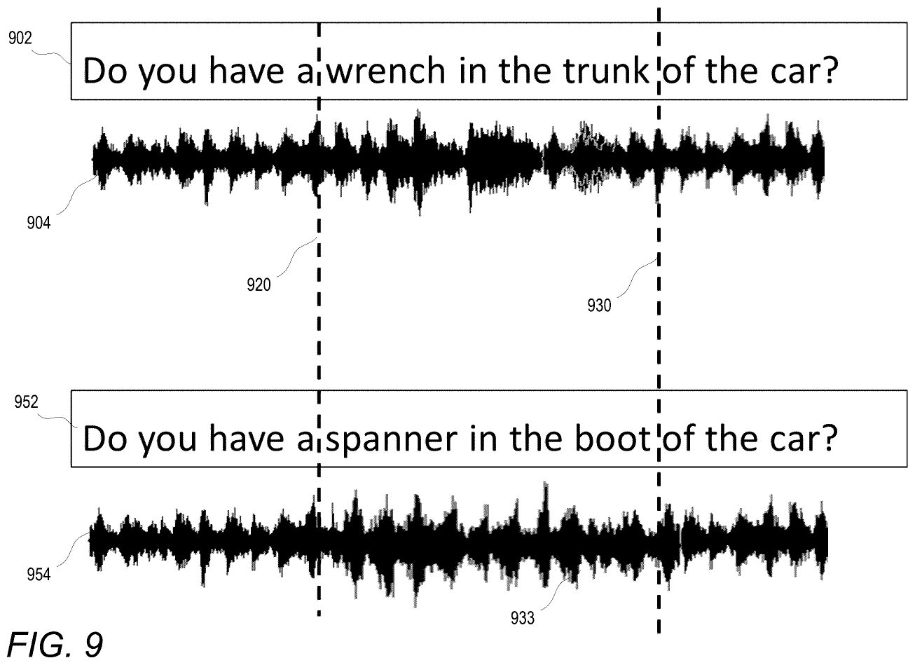

FIG. 9 depicts an example of dynamic content adaptation with audio, according to one or more embodiments. Continuing with the example shown in FIG. 8, FIG. 9 shows audio waveform 904 that includes an audio recording of the original content 902, which is identical to content 802 of FIG. 8. In one or more embodiments, the dynamic content adaptation can be performed with audio files, such as, a voicemail message recording. Continuing with the example, a caller can leave a voicemail message where the caller utters the phrase indicated at 902 into a microphone (e.g., similar to 108 of FIG. 1) to leave a voicemail message for another user. The voicemail message may be stored in a server, such as server 175 of FIG. 1, or other suitable server. Similar to as described for FIG. 8, to make the voicemail message well-suited for users who are most comfortable with UK English, the audio waveform 904 may be modified to create modified audio waveform 954, which contain audio of the dynamically adapted content shown in 952, which is identical to content 852 of FIG. 9. In one or more embodiments, one or more portions of the original audio waveform 904 may be replaced with dynamically adapted content to create modified audio waveform 954. In the example shown in FIG. 9, a segment start position is shown, indicated as 920, and a segment end position is shown, indicated at 930. The segment start position 920 and the segment end position 930 represent temporal points with the audio waveforms. In the example of FIG. 9, in the original audio waveform 904, the audio portion between the segment start position 920 and the segment end position 930 contains the phrase ‘wrench in the trunk.’ In the dynamically adapted content shown at 952, the audio portion between the segment start position 920 and the segment end position 930 has been replaced with a new audio portion 933 that contains the audio corresponding to the phrase ‘spanner in the boot’ which is in accordance with UK English. In one or more embodiments, the new audio portion 933 can be created via a text-to-speech process that executes on an electronic device, such as electronic device 201 of FIG. 2. In one or more embodiments, the new audio portion 933 can be created via a text-to-speech process that executes on a remote electronic device, such as application server 280 of FIG. 2, and then is transmitted to the electronic device (e.g., 201 of FIG. 2), which outputs the audio content via an output device, such as an audio speaker. In one or more embodiments, the text-to-speech process utilizes generative AI that is trained on the caller's voice, as to generate replacement text in a voice that is similar to the caller's own voice. In this way, disclosed embodiments can create dynamically adapted audio content that replaces one or more segments of the original audio waveform with a new audio waveform created using an AI-generated voice that resembles the voice of the caller (person who created the original audio waveform). Accordingly, the modified audio waveform 954 is well-suited for listeners that may be familiar with UK English, but are unfamiliar with the particular regionalized words for American English shown at 912 and 914 in original content 902. While the example of FIG. 9 shows an example with word regionalization, other aspects of dynamically adapted content, such as idiomatic expressions, currency, units of measure, and/or other aspects may also be used with audio waveforms as described and shown in FIG. 9. One or more embodiments can include: identifying convertible audio information comprising a voice audio clip for each of one or more convertible audio information; and generating modified voice audio data comprising a substitution of each of the one or more items of convertible audio information in the source content with a corresponding AI-generated voice audio clip for use within the modified version of the source content.

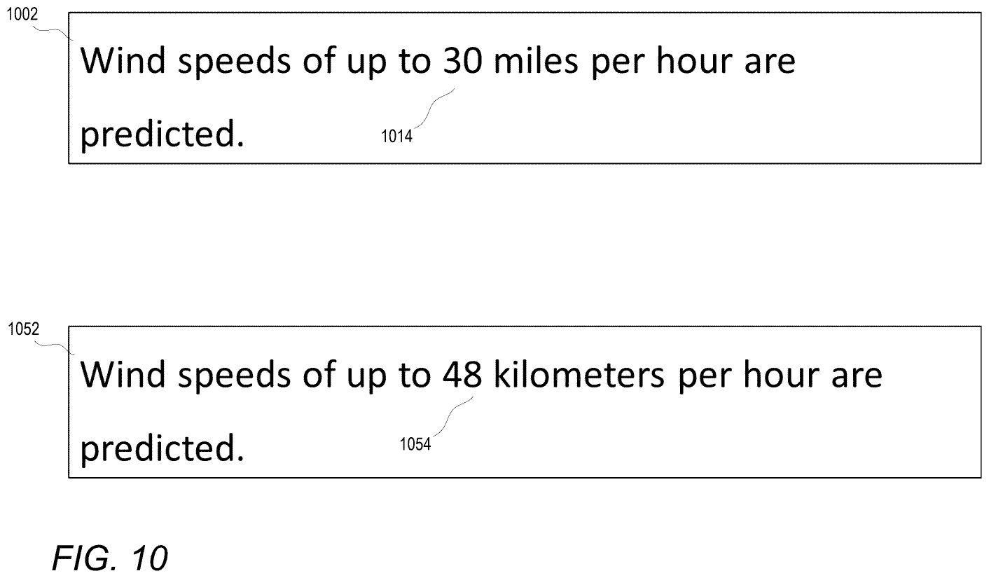

FIG. 10 depicts an example of dynamic content adaptation showing conversion of a unit of measurement, according to one or more embodiments. Content 1002 contains a sentence: “Wind speeds of up to 30 miles per hour are predicted.” The content 1002 contains a value indicated in miles per hour, shown at 1014, which is a standard unit of measurement. For a reader not familiar with standard measurement units, such as miles, inches, feet, etc., the content 1002 can be challenging to completely comprehend. Disclosed embodiments perform dynamic content adaptation to render adapted content 1052, which is well-suited for a reader that is more familiar with the metric system. The value in miles per hour indicated at 1014 is converted to kilometers per hour as indicated at 1054. In one or more embodiments, the conversion may be approximate, and rounding up or down may be performed as part of the conversion. Thus, disclosed embodiments can include: identifying a measurement and unit of measurement in the source content; determining a default unit of measurement based on the user profile data; and in response to the default unit of measurement not matching the unit of measurement in the source content, converting the measurement to the default unit of measurement within the modified version of the source content.

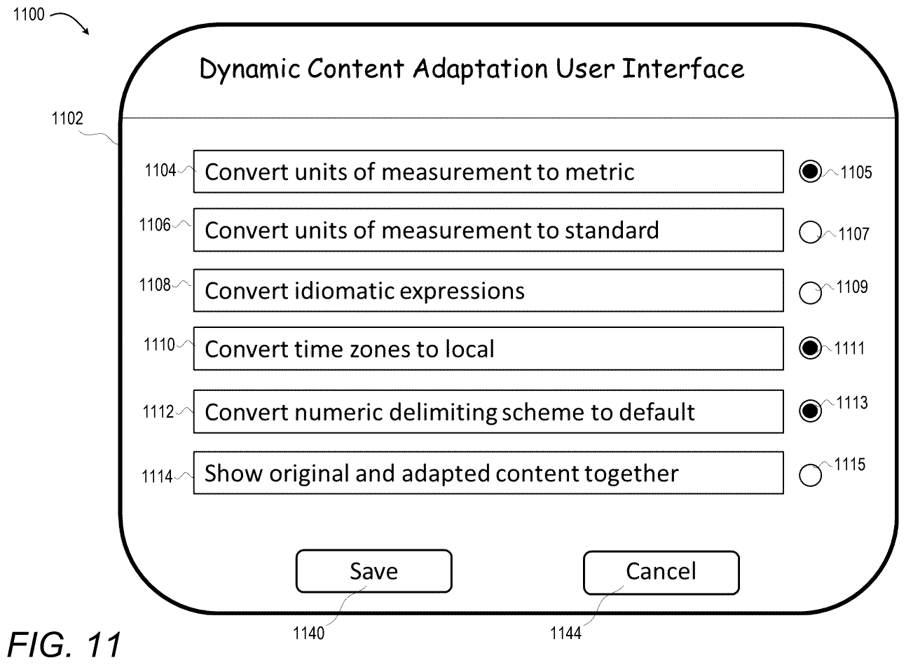

FIG. 11 shows an exemplary user interface 1100 for configuring dynamic content adaptation options, according to one or more embodiments. In one or more embodiments, the user interface shown in FIG. 11 may be rendered on a display 1102 of a device, such as device 100 of FIG. 1. In one or more embodiments, the user interface can include an option 1104 to convert non-metric units of measurement to metric. As shown at corresponding radio button 1105, the option 1104 is enabled. An example of showing conversion of units of measurement is depicted at 1052 of FIG. 10. In one or more embodiments, the user interface can include an option 1106 to convert non-standard units of measurement to standard. As shown at corresponding radio button 1107, the option 1106 is disabled. In one or more embodiments, the user interface can include an option 1108 to convert idiomatic expressions to literal text. As shown at corresponding radio button 1109, the option 1108 is disabled. An example of showing conversion of an idiomatic expression to literal text is depicted at 452 of FIG. 4.

In one or more embodiments, the user interface can include an option 1110 to convert non-local time zones to local time. As shown at corresponding radio button 1111, the option 1110 is enabled. In one or more embodiments, the user interface can include an option 1112 to convert a numeric delimiting scheme to a default. As shown at corresponding radio button 1113, the option 1112 is enabled. An example of showing conversion of a numeric delimiting scheme to a default is depicted at 752 of FIG. 7. In one or more embodiments, the user interface can include an option 1114 to show original and adapted content together. As shown at corresponding radio button 1115, the option 1114 is disabled. An example of showing original and adapted content together is depicted at 552 of FIG. 5.

The aforementioned options and/or configurations may be saved by invoking the save button 1140, which causes the electronic device to save the options and/or configuration to memory of the electronic device. The cancel button 1144, when invoked, causes the electronic device to discard any unsaved changes to options and/or configuration that were made.

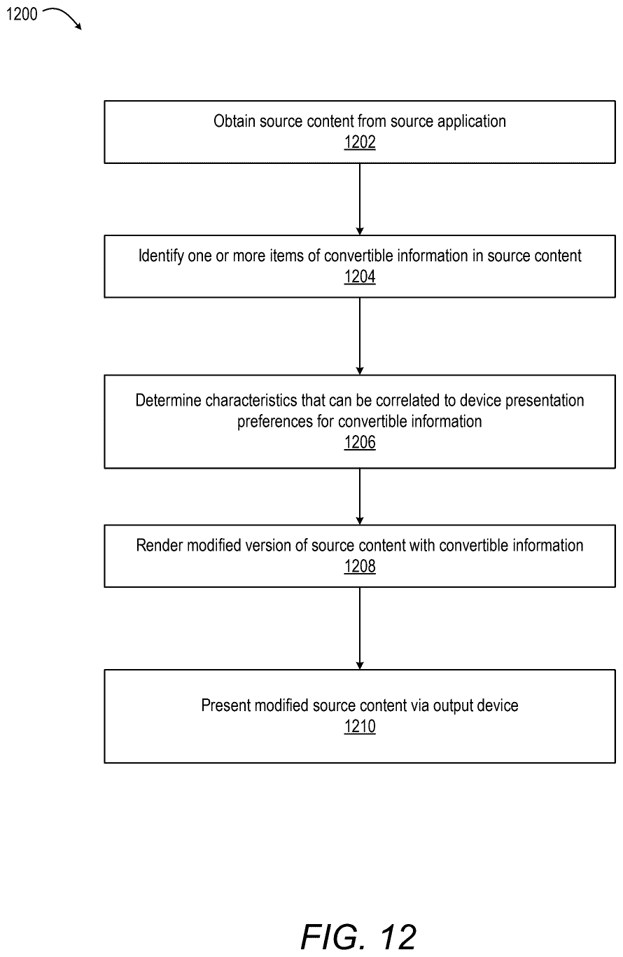

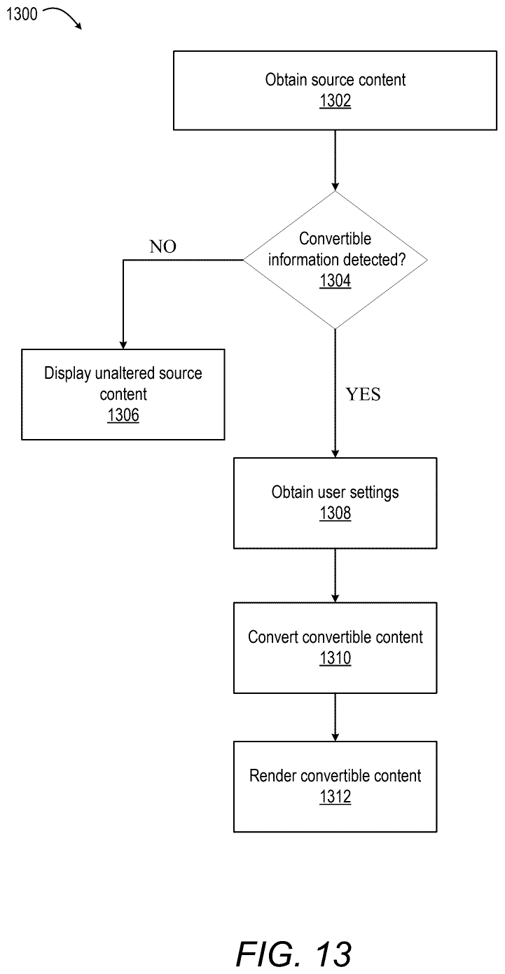

Referring now to the flowcharts presented by FIG. 12 and FIG. 13, the descriptions of the methods in FIG. 12 and FIG. 13 are provided with general reference to the specific components and features illustrated within the preceding FIGS. 1-11. Specific components referenced in the methods of by FIG. 12 and FIG. 13 may be identical or similar to components of the same name used in describing preceding FIGS. 1-11. In one or more embodiments, processor 102 (FIG. 1) configures electronic device 100 (FIG. 1) to provide the described functionality of the methods of FIG. 12 and FIG. 13 by executing program code for one or more modules or applications provided within system memory 120 of electronic device 100, including DCA module 152 (FIG. 1).

FIG. 12 depicts a flowchart of a computer-implemented method 1200 for dynamic content adaptation, according to one or more embodiments. The method 1200 starts at block 1202, where source content is obtained from a source application. In one or more embodiments, the source content can include text content. The text content can contain units of measurement, times indicated in one or more time zones, regionalized words (words that tend be used in a particular region, e.g., United States, UK, etc.), idiomatic expressions, numeric conventions, numeric delimiting schemes, currency values and/or currency types, and/or other information. The source application can include a browser, a messaging application, an email application, a notification presenting/surfacing application, and/or other types of application that provide source text content. In one or more embodiments, the source content can include audio content. The audio content can contain units of measurement, times indicated in one or more time zones, regionalized words, idiomatic expressions, numeric conventions, numeric delimiting schemes, currency values and/or currency types, and/or other information. The source application can include a voicemail application, an audio player application, a multimedia application, and/or other types of application that provide audio content. The method 1200 continues with identifying one or more items of convertible information at block 1204. In one or more embodiments, the one or more items of convertible information can include units of measurement, times indicated in one or more time zones, regionalized words, idiomatic expressions, numeric conventions, numeric delimiting schemes, currency values and/or currency types, and/or other information. The method 1200 continues to block 1206 where characteristics that can be correlated to device preferences for convertible information are determined. The device preferences can include options to show original content concurrently with the dynamically adapted content. The device preferences can include options to convert idiomatic expressions to literal text. The device preferences can include options to convert regionalized words and/or idiomatic expressions to other regions. The device preferences can include options to convert between standard and metric units of measurement. The device preferences can include options to convert non-local times to a local time zone. Other preferences are possible in one or more embodiments. Examples of device preferences are shown in FIG. 11. The method 1200 continues to block 1208 where a modified version of source content with convertible information is created and/or rendered. The method 1200 then continues to block 1210, where the modified source content is presented via an output device, such as an electronic display and/or audio speaker.

FIG. 13 depicts a flowchart of an additional computer-implemented method 1300 for dynamic content adaptation, according to one or more embodiments. The method 1300 starts at block 1302, where source content is obtained. The method 1300 continues to block 1304 where a check is made to determine if convertible information is detected. In one or more embodiments, the convertible information may be detected via pattern matching (e.g., regular expressions), and/or natural language processing (NLP) techniques. If, at block 1304, no convertible information is detected, the method 1300 continues to block 1306, where the source content is displayed unaltered. If instead, at block 1304, there is one or more items of convertible information detected, the method 1300 continues to block 1308 where user settings are obtained. The user settings can include preferences established by a user for how he/she prefers convertible information to be presented. The method 1300 continues to block 1310 where the convertible information is converted. The conversion can include converting standard units to metric units, converting idiomatic expressions to literal text, converting regionalized words and/or idiomatic expressions from one region (e.g., American) to another region (e.g., UK), and/or other types of conversions. In one or more embodiments, the dynamic conversion of content can occur on an electronic device, such as device 201 of FIG. 2. Alternatively, in one or more embodiments, the content can be sent from a device such as 201 to a remote device such as application server 280 of FIG. 2, and the remote device creates the converted content and sends the converted content to the electronic device 201 for presentation. The method 1300 continues to block 1312 where the convertible content is rendered and/or output on an output device such as an electronic display and/or audio speaker.

As can now be appreciated, disclosed embodiments provide techniques for converting regionalized words, idiomatic expressions, units of measurements, and other language conventions to aid in understanding global content. Disclosed embodiments help to bridge linguistic gaps, allowing people from different regions to understand each other more easily. Moreover, disclosed embodiments can promote seamless communication across diverse cultures, promoting global collaboration and understanding. One or more embodiments provide automatic conversion of idiomatic expressions and cultural nuances. Idioms are often unique to specific languages or regions. Idiomatic expressions might be confusing if interpreted literally. Converting idiomatic expressions ensures that the intended meaning is preserved. Thus, disclosed embodiments provide automatic conversion of language conventions that facilitate global communication, cultural exchange, and efficient collaboration.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one output device, including a display;
a memory having stored thereon a dynamic content adaptation (DCA) module; and
at least one processor communicatively coupled to the display and the memory, the at least one processor executing program code of the DCA module, and is configured to cause the electronic device to:
obtain source content from a source application;
identify one or more items of convertible information within the source content;
determine, in part based on user profile data associated with a user of the electronic device, characteristics that can be correlated to device presentation preferences for one or more convertible information items outputted on the electronic device, wherein the one or more convertible information items are presented within the source content using a different presentation format than renderable presentation alternatives that match the device presentation preferences for at least one of the one or more convertible information items;
render a modified version of the source content with the at least one of the one or more items of convertible information converted to its renderable presentation alternative for presentation on the electronic device; and
present the modified version of the source content via the at least one output device.

2. The electronic device of claim 1, wherein to convert the one or more items of convertible information, the at least one processor is further configured to:
identify a measurement and unit of measurement in the source content;
determine a default unit of measurement based on the user profile data; and
in response to the default unit of measurement not matching the unit of measurement in the source content, convert the measurement to the default unit of measurement within the modified version of the source content.

3. The electronic device of claim 1, wherein to convert the one or more items of convertible information, the at least one processor is further configured to:
identify a currency amount and currency type in the source content;
determine a default currency type based on the user profile data; and
in response to the default currency type not matching the currency type in the source content, convert the currency amount to the default currency type within the modified version of the source content.

4. The electronic device of claim 1, wherein to convert the one or more items of convertible information, the at least one processor is further configured to:
identify a time and corresponding time zone in the source content;
determine a default time zone based on the user profile data; and
in response to the default time zone not matching the time zone in the source content, convert the time to the default time zone within the modified version of the source content.

5. The electronic device of claim 1, wherein to convert the one or more items of convertible information, the at least one processor is further configured to:
identify an idiomatic expression in the source content;
obtain a corresponding idiomatic expression based on the user profile data; and
replace the idiomatic expression in the source content with the corresponding idiomatic expression within the modified version of the source content.

6. The electronic device of claim 1, wherein to render the source content with at least one of the one or more convertible information items converted to its renderable presentation alternative for presentation on the electronic device, the at least one processor is further configured to:
identify a numeric value and a numeric delimiting scheme in the source content;
determine a default numeric delimiting scheme based on the user profile data; and
in response to the default numeric delimiting scheme not matching the numeric delimiting scheme in the source content, apply the default numeric delimiting scheme to the numeric value.

7. The electronic device of claim 1, wherein the source content includes text, and wherein further the at least one processor is configured to render, on the display, each of the one or more items of convertible information in the source content, concurrently with a corresponding renderable presentation alternative.

8. The electronic device of claim 1, wherein the source content includes voice audio data, and wherein further the at least one processor is configured to:
identify convertible audio information comprising a voice audio clip for each of one or more convertible audio information; and
generate modified voice audio data comprising a substitution of each of the one or more items of convertible audio information in the source content with a corresponding AI-generated voice audio clip for use within the modified version of the source content.

9. A method comprising:
obtaining, by a processor of an electronic device that comprises a display, source content from a source application;
identifying one or more items of convertible information within the source content;
determining, in part based on user profile data associated with a user of the electronic device, characteristics that can be correlated to device presentation preferences for one or more convertible information items outputted on the electronic device, wherein the one or more convertible information items are presented within the source content using a different presentation format than renderable presentation alternatives that match the device presentation preferences for at least one of the one or more convertible information;
rendering a modified version of the source content with the at least one of the one or more items of convertible information converted to its renderable presentation alternative for presentation on the electronic device; and
presenting the modified version of the source content via the at least one output device.

10. The method of claim 9, further comprising:
identifying a measurement and unit of measurement in the source content;
determining a default unit of measurement based on the user profile data; and
in response to the default unit of measurement not matching the unit of measurement in the source content, converting the measurement to the default unit of measurement within the modified version of the source content.

11. The method of claim 9, further comprising:
identifying a currency amount and currency type in the source content;
determining a default currency type based on the user profile data; and
in response to the default currency type not matching the currency type in the source content, converting the currency amount to the default currency type within the modified version of the source content.

12. The method of claim 9, further comprising:
identifying a time and corresponding time zone in the source content;
determining a default time zone based on the user profile data; and
in response to the default time zone not matching the time zone in the source content, converting the time to the default time zone within the modified version of the source content.

13. The method of claim 9, further comprising:
identifying an idiomatic expression in the source content;
obtaining a corresponding idiomatic expression based on the user profile data; and
replacing the idiomatic expression in the source content with the corresponding idiomatic expression within the modified version of the source content.

14. The method of claim 9, further comprising:
identifying a numeric value and a numeric delimiting scheme in the source content;
determining a default numeric delimiting scheme based on the user profile data; and
in response to the default numeric delimiting scheme not matching the numeric delimiting scheme in the source content, applying the default numeric delimiting scheme to the numeric value.

15. The method of claim 9, further comprising rendering, on the display, each of the one or more items of convertible information in the source content, concurrently with a corresponding renderable presentation alternative.

16. The method of claim 9, further comprising:
identifying convertible audio information comprising a voice audio clip for each of one or more convertible audio information; and
generating modified voice audio data comprising a substitution of each of the one or more items of convertible audio information in the source content with a corresponding AI-generated voice audio clip for use within the modified version of the source content.

17. A computer program product comprising a non-transitory computer readable medium having program instructions that when executed by a processor of an electronic device comprising a display, configure the electronic device to perform functions comprising:
obtaining source content from a source application;
identifying one or more items of convertible information within the source content;
determining, in part based on user profile data associated with a user of the electronic device, characteristics that can be correlated to device presentation preferences for one or more convertible information items outputted on the electronic device, wherein the one or more convertible information items are presented within the source content using a different presentation format than renderable presentation alternatives that match the device presentation preferences for at least one of the one or more convertible information;
rendering a modified version of the source content with the at least one of the one or more items of convertible information converted to its renderable presentation alternative for presentation on the electronic device; and
presenting the modified version of the source content via the at least one output device.

18. The computer program product of claim 17, further comprising program instructions for:
identifying a currency amount and currency type in the source content;
determining a default currency type based on the user profile data; and
in response to the default currency type not matching the currency type in the source content, converting the currency amount to the default currency type within the modified version of the source content.

19. The computer program product of claim 17, further comprising program instructions for:
identifying an idiomatic expression in the source content;
obtaining a corresponding idiomatic expression based on the user profile data; and
replacing the idiomatic expression in the source content with the corresponding idiomatic expression within the modified version of the source content.

20. The computer program product of claim 17, further comprising program instructions for rendering, on the display, each of the one or more items of convertible information in the source content, concurrently with a corresponding renderable presentation alternative.
